(19) United States
(12) Patent Application Publication
(10) Pub. No.: US 2011/0017168 A1
(43) Pub. Date: Jan. 27, 2011

(54) WEIGHTED CENTRIFUGAL CLUTCH

(75) Inventor: Richard J. Gilpatrick, Whitewater, WI (US)

Correspondence Address: Foley & Lardner LLP, 777 East Wisconsin Avenue, Milwaukee, WI, 53202-5306, US

(73) Assignee: Briggs & Stratton Corporation

(21) Appl. No.: 12/509,215

(22) Filed: Jul. 24, 2009

(51) Int. Cl. F02B 75/32; F16D 47/02; F16C 15/00; F04B 17/05

(52) U.S. Cl. 123/197.5; 192/201; 74/572.2; 417/364; 137/565.01

(57) ABSTRACT

A pressure washer system includes a combustion engine having a power takeoff. The center of the power takeoff defines an axis of rotation. The pressure washer system further includes a centrifugal clutch coupled to the power takeoff. The clutch comprises a flywheel having a center of mass positioned along the axis of rotation. The pressure washer system also includes a water pump coupled to the clutch output shaft.

### BACKGROUND

The present invention relates generally to the field of power equipment driven by small combustion engines. More specifically the present invention relates to power equipment employing a centrifugal clutch between an engine and a powered tool.

Kick back may occur in combustion engines when ignition occurs before a piston reaches top dead center and the momentum pushing the piston is insufficient to drive the piston through the top dead center position. Instead the piston fails to reach top dead center, and the crankshaft of the engine is driven in the reverse direction. Such kick back may especially occur during engine startup. For example, if insufficient force is applied to a recoil starter, then the momentum behind the piston may be insufficient to avoid kick back.

Some power equipment, such as rotary lawn mowers with vertical shaft engines, address the kick back issue by storing much of the pull force of a recoil starter in rotational inertia of the tool (the blade). However other powered tools, such as pressure washer pumps, may increase the likelihood of kick back because such powered tools resist rotation of the crankshaft without storing the startup pull force as rotational momentum of the powered tool. To compensate, heavy flywheels, typically formed from iron or zinc, are used to store a sufficient amount of rotational momentum to push the piston through the top dead center position during startup. Such heavy flywheels add manufacturing expense, and a large flywheel mass may be required in order to prevent kick back. Conversely, lawn mowers are able to use lightweight aluminum flywheels that are much easier to produce. Inertia from the lawn mower cutting blade compensates for reduced inertia of lightweight flywheels.

### SUMMARY

One embodiment of the invention relates to a pressure washer system. The pressure washer system includes a combustion engine having a power takeoff. The center of the power takeoff defines an axis of rotation. The pressure washer system further includes a centrifugal clutch coupled to the power takeoff. The clutch comprises a flywheel having a center of mass positioned along the axis of rotation. The pressure washer system also includes a water pump coupled to the clutch output shaft.

Another embodiment of the invention relates to an engine for power equipment. The engine comprises a crankshaft with a power takeoff, a recoil starter or an electric starter is attached to the crankshaft, and a centrifugal clutch attached to the power takeoff. The centrifugal clutch includes a clutch hub, and two or more shoes coupled to the clutch hub. The shoes are movable along tracks extending from the clutch hub. Also, the shoes are biased in a retracted position. The centrifugal clutch also includes a clutch drum having a wall. Friction between the shoes and the wall releasably fastens the shoes to the wall, when the shoes are in an extended position. Additionally the centrifugal clutch includes a clutch output shaft coupled to the clutch drum. The clutch output shaft is designed to engage a powered tool. The shoes of the centrifugal clutch are biased such that use of the recoil starter or the electric starter produces an insufficient rate of rotation of the crankshaft to engage the clutch, while a running speed of the engine produces a sufficient rate of rotation of the crankshaft to drive the shoes to the extended position, engaging the clutch.

Yet another embodiment of the invention relates to a centrifugal clutch. The centrifugal clutch includes a hub having an aperture designed to receive a power takeoff of a combustion engine. The centrifugal clutch also includes a flywheel fixed to the hub and two or more shoes coupled to the hub. The shoes are designed to move from a retracted position to an extended position. A sufficient rate of rotation of the clutch drives the shoes to the extended position. The flywheel extends further from the aperture than the shoes, in the extended position, are from the aperture. Additionally the centrifugal clutch includes a drum having a wall surrounding the shoes. The shoes grip the wall when the shoes are in the extended position, while the hub is permitted to rotate relative to the drum when the shoes are in the retracted position. The centrifugal clutch also includes an output shaft attached to the drum. The output shaft has a keyway or an integrated key designed to engage a powered tool.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a pressure washer according to an exemplary embodiment.

FIG. 2A is a sectional view of an engine with a recoil starter according to an exemplary embodiment.

FIG. 2B is a sectional view of an engine with an electric starter according to an exemplary embodiment.

FIG. 2C is a sectional view of a clutch according to an exemplary embodiment.

FIG. 3A is a perspective view of a clutch according to another exemplary embodiment.

FIG. 3B is a perspective view of a clutch according to yet another exemplary embodiment.

FIG. 4 is a perspective view of a clutch according to still another exemplary embodiment.

FIG. 5 is a perspective view of a clutch hub according to an exemplary embodiment.

FIG. 6A is a sectional view of a flywheel for a clutch according to an exemplary embodiment

FIG. 6B is an exploded view of a clutch according to an exemplary embodiment.

FIG. 7A is a side view of a flywheel according to another exemplary embodiment.

FIG. 7B is a perspective view of the flywheel of FIG. 7A.

### DETAILED DESCRIPTION OF THE EXEMPLARY EMBODIMENTS

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

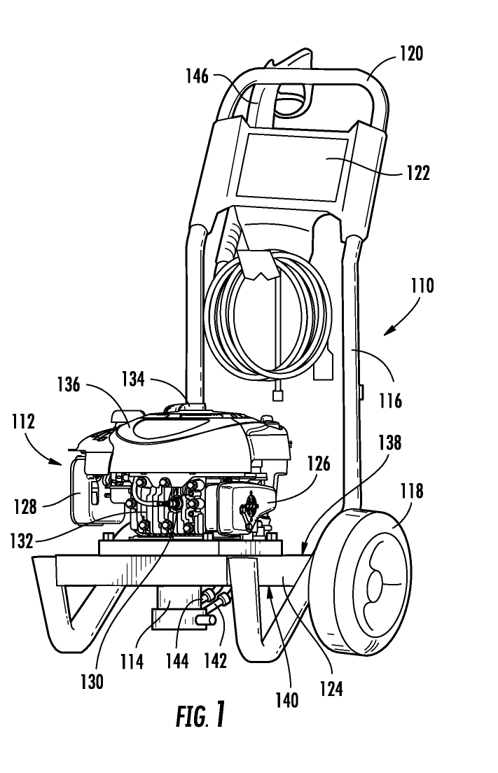

Referring to FIG. 1, a pressure washer 110 includes an internal combustion engine 112, a water pump 114, and a support structure 116. The support structure 116 includes wheels 118, a handle 120, a console 122, and a base plate 124. The internal combustion engine 112 is a small engine with a vertical shaft, and includes a muffler 126, an air intake 128, a spark plug 130 extending through a cylinder head 132, and a recoil starter 134 integrated with a cover 136. The internal combustion engine 112 is mounted to a top side 138 of the base plate 124, and the water pump 114 is mounted to an underside 140 of the base plate 124. The water pump 114 includes an inlet 142 and an outlet 144, where the inlet 142 is designed to be coupled to a water source, such as a bibcock or faucet. A spray gun 146 held on the support structure 116 may be coupled to the outlet 144 of the water pump 114. The water pump 114 shown in FIG. 1 is an axial cam pump.

In other embodiments, pressure washers are powered by a diesel engine, an electric motor, a combustion engine with a horizontal shaft, or another form of motor. In some embodiments, the water pump may be a centrifugal water pump, a duplex water pump (i.e., a positive displacement pump with two pistons), a triplex water pump, or another type of pump. The pump 114 may be mounted on the top side 138 of the base plate 124, on the top of an engine, or otherwise mounted. The present disclosure may be used with other types of power equipment, such as a rotary tiller, an emergency or home power generator, or another form of power equipment.

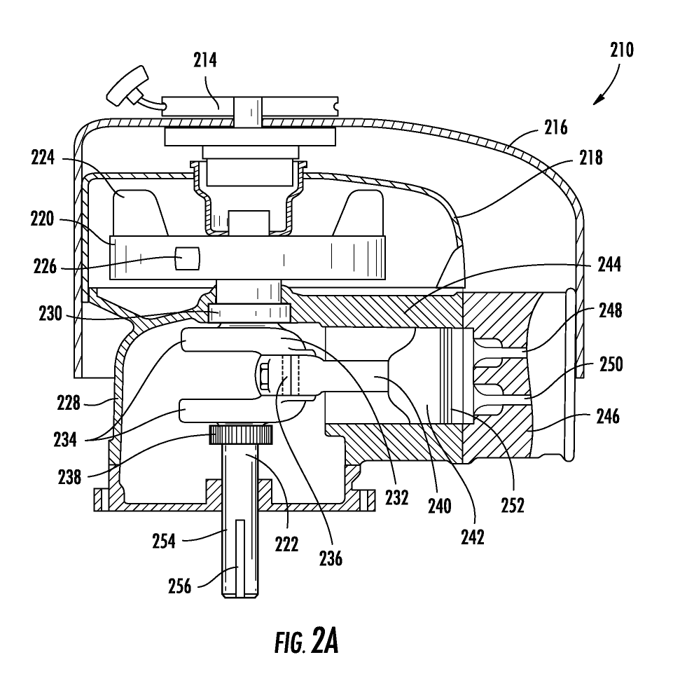

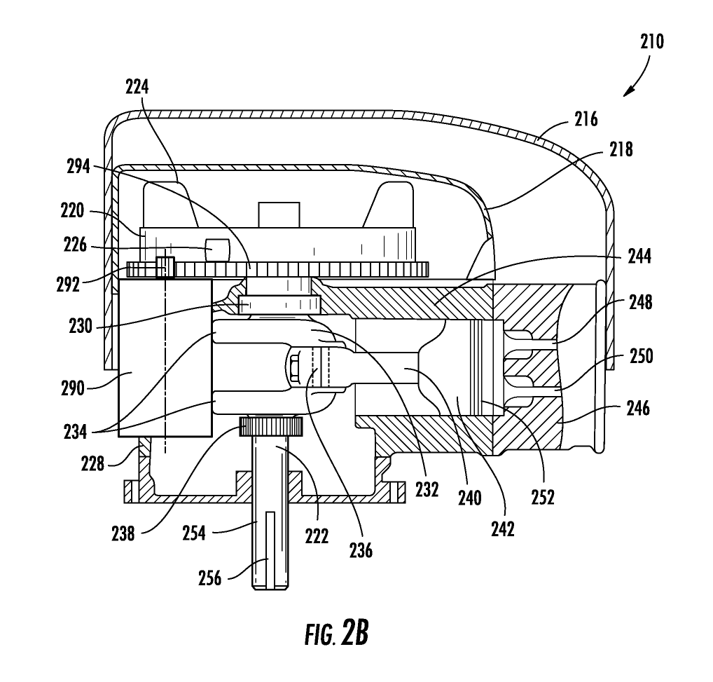

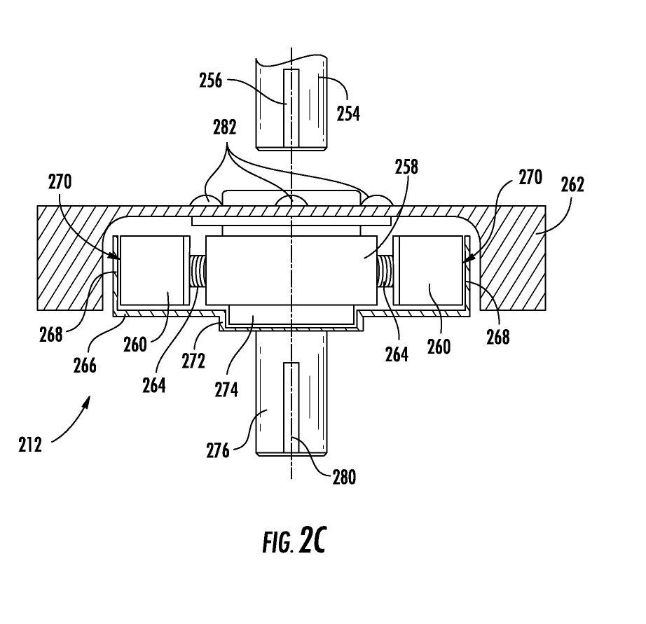

Referring to FIGS. 2A-2C, a centrifugal clutch 212 shown in FIG. 2C is designed to attach to a power takeoff 254 of a combustion engine 210 shown in FIGS. 2A-2B. In FIG. 2A the engine 210 includes a recoil starter 214 attached to a cover 216, a blower scroll 218, and a flywheel 220 coupled to a crankshaft 222. The flywheel 220 includes blower fan blades 224 and a magnet 226 for an ignition system. Below the flywheel 220, the engine 210 includes a crankcase 228, where the crankshaft 222 extends into the crankcase 228 through a bearing 230. Within the crankcase 228, the crankshaft 222 includes webs 232, counterweights 234, a crankpin journal 236, and gearing 238. The gearing 238 may be used to couple the crankshaft 222 to a camshaft (not shown) or other components. Alternatively, in FIG. 2B the engine 210 includes an electric starter 290 with gearing 292 (e.g., a bendix gear) that interfaces with a gear 294 on the flywheel 220. When the flywheel 220 reaches a sufficient rate of rotation, the gearing 292 of the electric starter 290 disengages the gear 294.

Still referring to FIGS. 2A-2C, a connecting rod 240 of a piston 242 is rotatably coupled to the crankpin journal 236. The piston 242 extends within a cylinder block 244. A cylinder head 246, with intake and exhaust valves 248, 250, is mounted to the cylinder block 244, where a combustion chamber 252 is formed between the piston 242, the cylinder block 244, and the cylinder head 246. Referring to the crankshaft 222, the power takeoff 254 extends through the crankcase 228, below the engine 210. The power takeoff 254 includes a keyway 256 and is designed to couple to another device, such as a powered tool or the centrifugal clutch 212.

The recoil starter 214 or the electric starter 290 may be used to activate the engine 210, rotating the crankshaft 222 and the flywheel 220. As the flywheel 220 rotates, the fan blades 224 blow air, guided by the blower scroll 218, over the cylinder head 246 and cylinder block 244, to transfer heat generated by combustion occurring within the combustion chamber 252. Also as the flywheel 220 rotates, the magnet 226 passes an ignition armature (not shown), generating a current that is converted to a spark to ignite fuel in the combustion chamber 252. Rotational power of the crankshaft 222, driven by the piston 242, is transferred from the engine 210 via the power takeoff 254.

The flywheel 220 supports the blower fan blades 224 and the magnet 226 for the ignition system, but may not hold much rotational momentum. In some exemplary embodiments, the flywheel 220 is formed from aluminum, ceramic, plastic, composite, or other lightweight materials. According to an exemplary embodiment, the flywheel 220 has a low mass moment of inertia, storing a relatively small amount of rotational momentum when compared to flywheels of comparable dimensions that are formed from iron, zinc, or other similar materials.

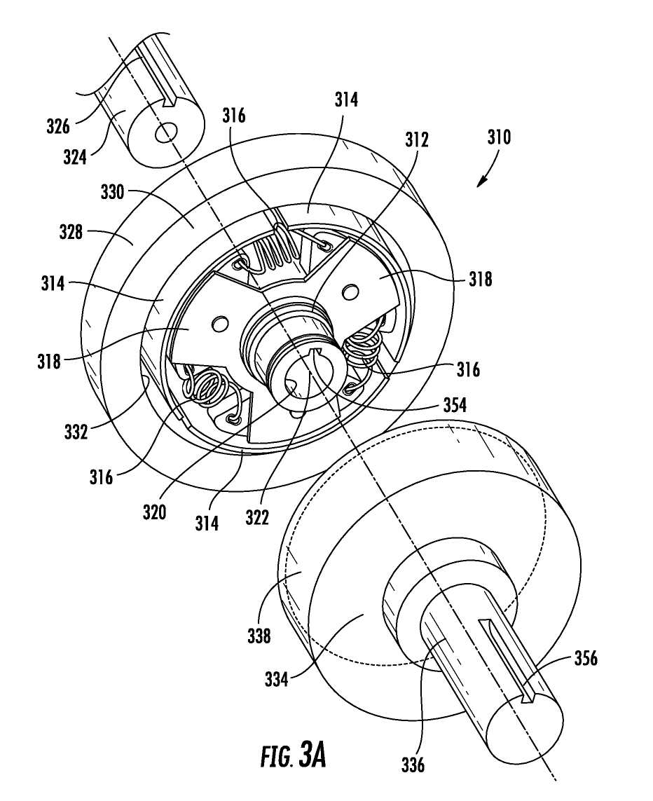

Referring to FIG. 2C, the centrifugal clutch 212 includes a clutch hub 258, with shoes 260 surrounding the hub 258, and an auxiliary flywheel (i.e., a weighted member designed to store rotational moment) in the form of a metal disk 262. The hub 258 also includes a central aperture (see, e.g., aperture 320 shown in FIG. 3A) through which the power takeoff 254 of the engine 210 engages the clutch 212. Springs 264 bias the shoes 260 into a retracted position. The shoes 260 may translate to an extended position when the bias is overcome. In the extended position the shoes 260 are further from the hub 258 than shoes 260 are from the hub 258 when the shoes 260 are in the retracted position. The clutch 212 further includes a clutch drum 266 with a wall 268 surrounding the shoes 260. When the shoes 260 are in the extended position, outside surfaces 270 of the shoes 260 contact the wall 268. While the shoes 260 are in the retracted position, the outside surfaces 270 do not contact the wall 268.

The clutch drum 266 further includes a bearing in the form of a bushing 272. A mandrel 274 or boss of the hub 258 extends into the bushing 272, coupling the hub 258 to the drum 266, while also allowing the hub 258 and the drum 266 to rotate relative to each other. The mandrel 274 and bushing 272 serve to pilot the hub 258 and drum 266 together along a common axis of rotation 280. In other embodiments, ball bearings, roller bearings, journal bearings, sleeve bearings, fluid bearings, magnetic bearings, or other types of bearings may be used. A clutch output shaft 276 is fixed to the drum 266, where rotation of the drum 266 rotates the clutch output shaft 276. The clutch output shaft 276 may be coupled to a powered tool, such as a pressure washer pump.

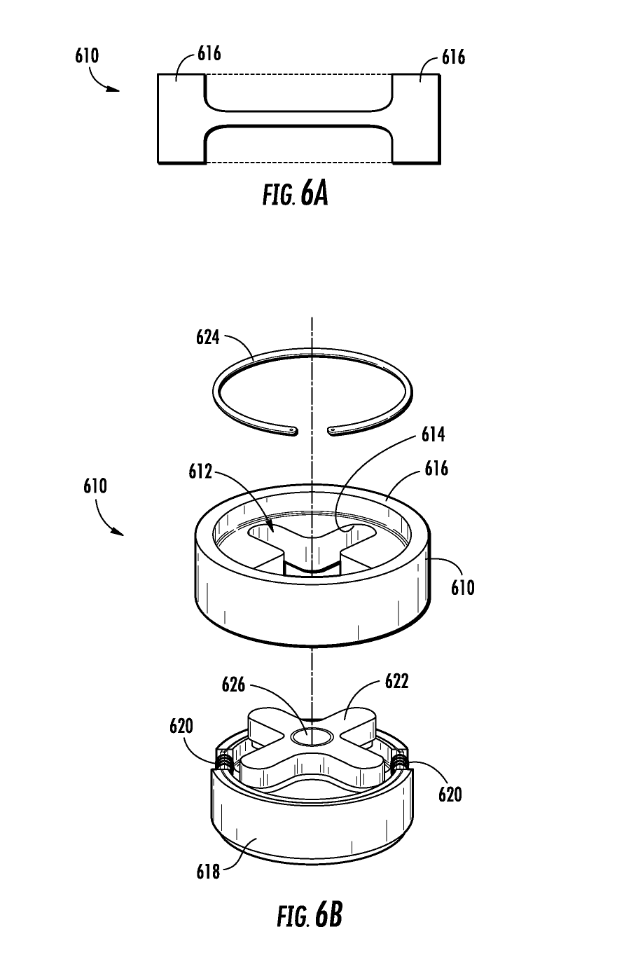

Still referring to FIG. 2C, rivets 282 hold the metal disk 262 to the hub 258. In other embodiments, screws, pins, welds, or other fasteners are used to fasten the metal disk 262 to the hub 258 (see, e.g., male and female couplings 614, 622 shown in FIG. 6B). In still other embodiments, the metal disk 262 is integrally formed with the hub 258.

Referring to FIG. 2A, when the recoil starter 214 is used to activate the engine 210, the recoil starter 214 rotates the power takeoff 254 via rotation of the crankshaft 222. However, the rate of rotation of the power takeoff 254 produced by a typical pull of the recoil starter 214 is designed to be insufficient to engage the clutch 212. Such a typical pull may range from about 15-100 lb, and more typically between 20-50 lb. As such, the hub 258 rotates relative to the drum 266 and does not transfer rotational power to the clutch output shaft 276, leaving the powered tool disengaged during startup. After the engine 210 as been successfully activated by the recoil starter 214, the rate of rotation of the crankshaft 222 (and power takeoff 254) increases beyond the rate of rotation produced by the recoil starter 214 during startup. The running speed of the engine 210 may then be sufficient to cause the shoes to translate to the extended position. Friction between the outside surfaces 270 of the shoes 260 and the wall 268 of the drum 266 binds the shoes 260 to the wall 268, causing the clutch output shaft 276 to drive the powered tool (i.e., engaging the centrifugal clutch). According to some exemplary embodiments, the centrifugal clutch 212 would engage when rotated as a rate between 1500-2000 revolutions per minute (rpm). A typical rotational speed of the engine power takeoff 254 during a normal pull start is about 600-800 rpm.

For some embodiments, operation of the electric starter 290 shown in FIG. 2B will not engage the centrifugal clutch 212 during startup. Following startup, when the flywheel 220 reaches a sufficient rate of rotation (e.g., disengaging the electric starter gear 292), the centrifugal clutch 212 will engage. In some embodiments, the electric starter 290 provides a torque and rate of rotation that is comparable to a typical pull of the recoil starter 214.

Referring to FIGS. 3A-3B, a centrifugal clutch 310 includes a hub 312 and three shoes 314 positioned around the hub 312. The shoes 314 are biased in a retracted position by springs 316. The shoes 314 are designed to translate along track plates 318 away from the hub 312 when the rate of rotation of the hub 312 produces reactive forces (often referred to as centrifugal forces) that overcome the bias of the springs 316. In FIG. 3A, the hub 312 includes a central aperture 320 in a center 322 of the hub 312 with a keyway 354, allowing a power takeoff 324 with a mating keyway 326 to be inserted through the aperture 320 and fixed to the hub 312 with a key (not shown). The key may be a rectangular block sized to slide into the mating keyways 322, 326 when the power takeoff 324 is within the aperture 320. The key may be formed from metal and designed to release the keyways 322, 326 (e.g., by fracturing) if shear forces between the power takeoff 324 and the clutch 310 exceed a threshold level. Alternatively in FIG. 3B, the hub 312 includes a key 350 integrated with an aperture 321 formed in a center 323 of the hub 312.

The clutch 310 also includes a flywheel in the form of a disk 328 with a lip 330 extending around the periphery of the disk 328. The disk 328 is rigidly fixed to the hub 312, such as by welding or riveting. An annular cavity 332 is formed by a space between the lip 330 of the disk 328 and the shoes 314, when the shoes 314 are in the retracted position. The clutch 310 shown in FIG. 3A further includes a drum 334 rigidly fixed to a clutch output shaft 336 with a keyway 356. Extending away from the output shaft 336, the drum 334 includes a circular wall 338. The wall 338 fits into the annular cavity 332, between the lip 330 and the shoes 314. When the wall 338 is positioned within the cavity 332, the lip 330 is separated from the wall 338, and the wall 338 is separated from the shoes 314, if the shoes 314 are in the retracted position. Alternatively, the clutch 310 shown in FIG. 3B includes a clutch output shaft 337 with a key 352.

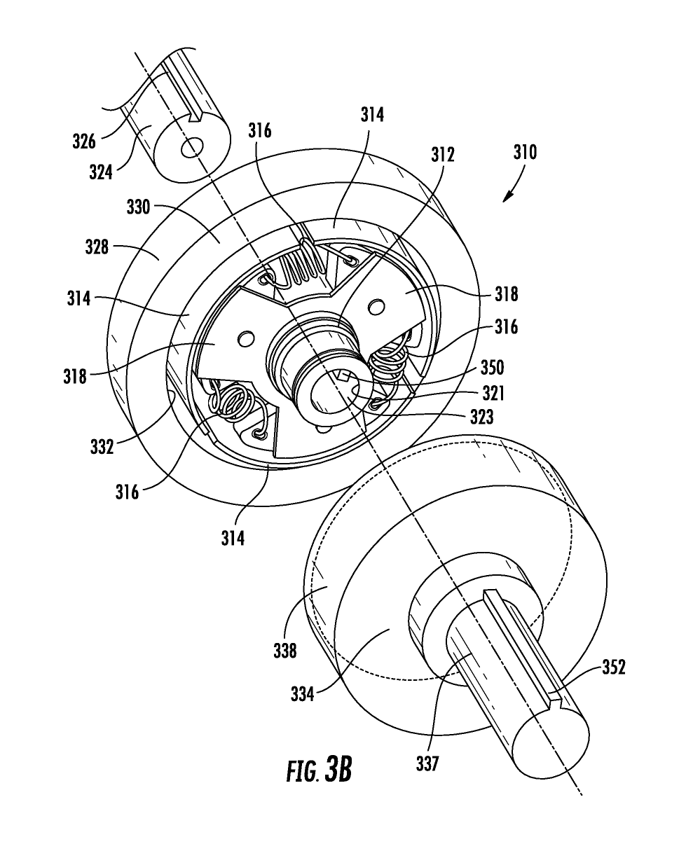

Referring to FIG. 4, a hub 412 of a centrifugal clutch 410 is surrounded by two shoes 414. The shoes 414 are positioned along guide tracks 416, allowing the shoes 414 to slide along the tracks 416, away from the hub 412. However, the shoes 414 are biased toward the hub 412 by springs 418. A flywheel in the form of a disk 420 is integrally formed with the hub 412.

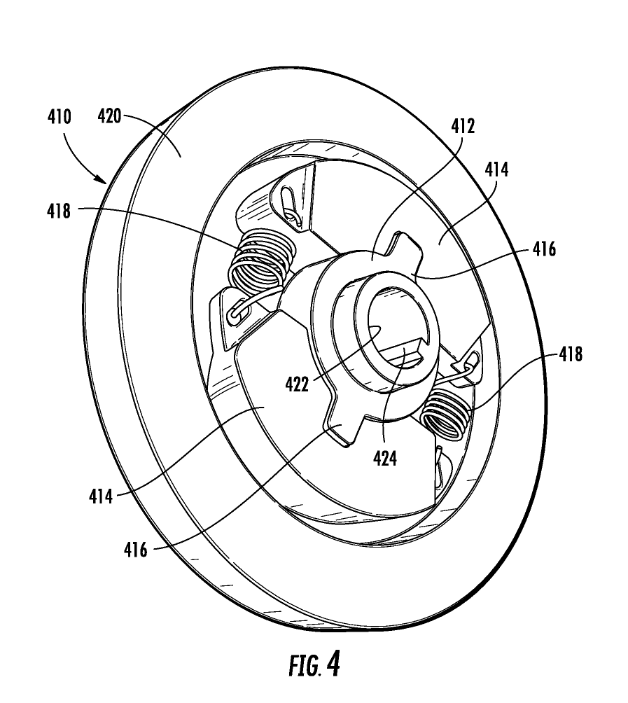

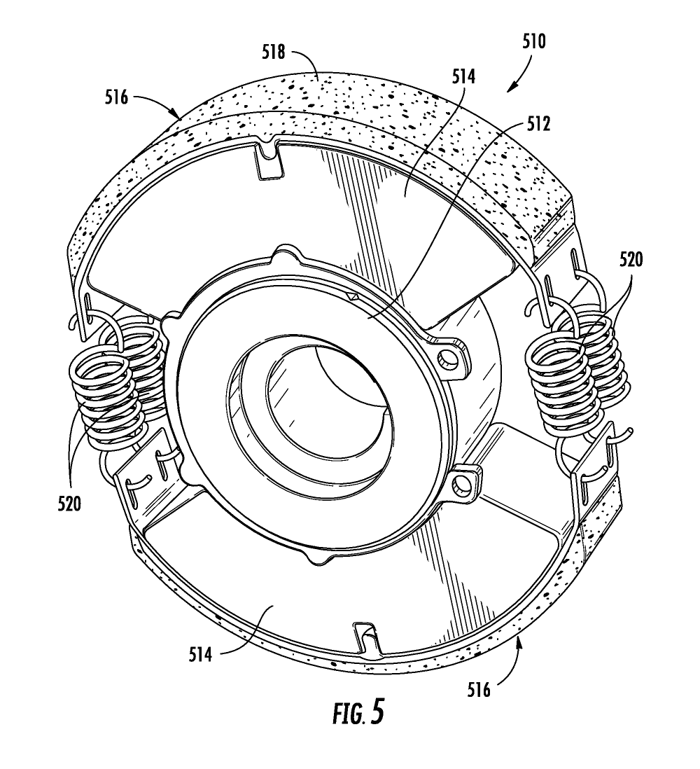

Referring to FIG. 5, a hub 512 of a centrifugal clutch 510 is surrounded by two shoes 514 with outer surfaces 516 of the shoes 514 covered by braking material 518. In some embodiments, the braking material 518 includes a semi-metallic material, as is commercially available for automobile brake pads. In other embodiments, ceramic compounds, coppers, or composites are used as braking material. In still other embodiments, mineral fibers, aramid fibers, and other braking materials are used.

Still referring to FIG. 5, the shoes 514 may be formed from heavy materials, such as powdered steel, iron, zinc, or combinations of materials. Springs 520 hold the shoes 514 in a retracted position. The shoes 514, in the retracted position, provide a large mass moment of inertia, comparable to the large mass moments of inertia provided by the auxiliary flywheels of some embodiments disclosed herein. As such, the shoes 514 dually function an auxiliary flywheel as well as to grip a drum when in the extended position. However, such embodiments may require a greater mass of weighted material than embodiments employing a flywheel extending further from the axis of rotation.

Referring to FIG. 6A, an annular-shaped flywheel 610 includes a lip 616 or ring of material extending around the periphery of the annular-shaped flywheel 610. The sectional profile shown in FIG. 6A shows the annular-shaped flywheel 610 to have an “H”-shaped cross-section, as opposed to the “C”-shaped cross-section of the metal disk 262 shown in FIG. 2.

Referring to FIG. 6B, the annular-shaped flywheel 610 includes a central aperture 612. Walls 614 of the aperture 612 form a female coupling for receiving a mating male extension 622 that extends from a clutch hub 618. The clutch hub 618 includes biased shoes 620 and an aperture 626 for receiving a power takeoff. A retaining ring 624 may hold the annular-shaped flywheel 610 and the chub 618 together.

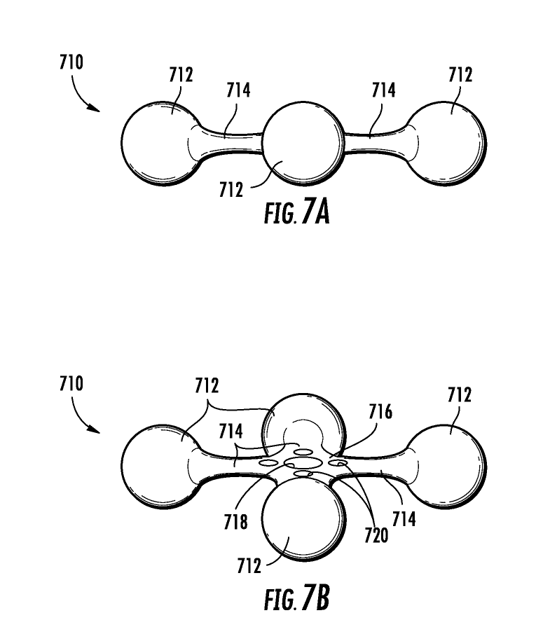

Referring to FIGS. 7A-7B, a flywheel in the form of a weighted cross 710 includes four weighted bulbs 712 connected by arms 714 to a center 716. The weighted cross 710 includes a central aperture 718 through which a power takeoff may extend. Additionally the weighted cross 710 includes holes 720 though which fasteners may be inserted to attach the weighted cross 710 to a centrifugal clutch hub. The center of mass of the weighted cross 710 is located within the center of the aperture 718. Other embodiments include auxiliary flywheels having a wide variety of geometries, including asymmetric geometries, while still having a center of mass aligned with the axis of rotation of the clutch.

In some embodiments, the centrifugal clutch is designed to have a mass moment of inertia within a range of 10-50 pounds-square inches (lb·in²), preferably 15-30 lb·in². Further, in some embodiments, the flywheel fixed to the clutch provides the main source of the mass moment of inertia for the clutch. For example, the mass moment of inertia of the flywheel is within a range of 5-40 lb·in², preferably 10-30 lb·in². The particular mass of the flywheel varies as a function of the dimensions of the flywheel.

In some embodiments, the shoes may be coupled to calipers, allowing the shoes to be positioned on both the inside and outside of the drum. In other embodiments, the shoes may be coupled to weighted levers, allowing the shoes to be positioned outside of the drum. In some embodiments, the frictional surfaces between the hub and the drum are along a plane perpendicular to the axis of rotation, where a weighted lever or some other driver pushes the surfaces together upon a sufficient rate of rotation. In still other embodiments, accelerometers may be used to measure the rate of rotation of the power takeoff, with a controller engaging the clutch when a threshold rate of rotation is achieved. Dampers may be used to control the rate of translation of the shoes. Multiple individual weights may be attached to a clutch, where the net center of mass of the individual weights is positioned along the axis of rotation.

The construction and arrangements of the pressure washer system, the engine, and the centrifugal clutch, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer system, comprising:
a combustion engine having a power takeoff, the center of the power takeoff defining an axis of rotation;
a centrifugal clutch coupled to the power takeoff, the clutch comprising a flywheel having a center of mass positioned along the axis of rotation; and
a water pump coupled to the clutch output shaft.

2. The system of claim 1, wherein the mass moment of inertia of the centrifugal clutch is between 10-50 lb·in².

3. The system of claim 2, wherein the water pump is at least one of an axial cam pump, a duplex water pump, or a triplex water pump.

4. The system of claim 3, wherein the flywheel is disk-shaped and formed from powdered metal.

5. The system of claim 4, wherein the centrifugal clutch further comprises a clutch hub positioned along the axis of rotation, two or more shoes coupled to the clutch hub and biased in a retracted position, a clutch drum having a wall positioned further from the axis of rotation than the shoes are from the axis of rotation, and a clutch output shaft coupled to the clutch drum, wherein the shoes are configured to translate from the retracted position to an extended position, and wherein the shoes contact the wall when the shoes are in the extended position.

6. The system of claim 5, wherein rotation of the power takeoff at a rate greater than a threshold rate drives the shoes into the extended position, and friction between the shoes and the wall engages the clutch.

7. The system of claim 6, further comprising a braking material coupled to the shoes.

8. An engine for power equipment, comprising:
a crankshaft with a power takeoff;
at least one of a recoil starter or an electric starter coupled to the crankshaft;
a centrifugal clutch coupled to the power takeoff, the centrifugal clutch comprising:
a clutch hub;
two or more shoes coupled to the clutch hub, the shoes translatable along tracks extending from the clutch hub, wherein the shoes are biased in a retracted position;
a clutch drum having a wall, wherein friction between the shoes and the wall releasably fastens the shoes to the wall when the shoes are in an extended position; and
a clutch output shaft coupled to the clutch drum, configured to engage a powered tool;
wherein the shoes are biased such that use of the at least one of a recoil starter or an electric starter produces an insufficient rate of rotation of the crankshaft to engage the clutch, and wherein a running speed of the engine produces a sufficient rate of rotation of the crankshaft to drive the shoes to the extended position, engaging the clutch.

9. The engine of claim 8, wherein the mass moment of inertia of the centrifugal clutch is between 10-50 lb·in².

10. The engine of claim 9, wherein the power takeoff rotates about an axis of rotation, and wherein the centrifugal clutch further comprises a flywheel with a center of mass positioned along the axis of rotation.

11. The engine of claim 10, wherein the flywheel is a disk and includes a lip extending around the periphery of the disk.

12. The engine of claim 11, wherein the clutch is arranged such that the clutch hub is positioned closer to the axis of rotation than the shoes are to the axis of rotation, the shoes are closer to the axis of rotation than the wall of the clutch drum is to the axis of rotation, and the wall of the clutch drum is closer to the axis of rotation than the lip of the disk is to the axis of rotation.

13. The engine of claim 12, wherein the majority of mass of the flywheel is positioned further from the axis of rotation than the wall of the clutch drum is from the axis of rotation.

14. The engine of claim 13, wherein the clutch output shaft is configured to engage at least one of a rotary tiller, a home power generator, a pressure washer pump, or a water pump.

15. A centrifugal clutch, comprising:
a hub having an aperture configured to receive a power takeoff of a combustion engine;
a flywheel fixed to the hub;
two or more shoes coupled to the hub, the shoes configured to translate from a retracted position to an extended position, wherein a sufficient rate of rotation of the clutch drives the shoes to the extended position, and wherein the flywheel extends further from the aperture than the shoes, in the extended position, are from the aperture;
a drum having a wall surrounding the shoes, wherein the shoes grip the wall when the shoes are in the extended position, wherein the hub is permitted to rotate relative to the drum when the shoes are in the retracted position; and
an output shaft coupled to the drum and having at least one of a keyway or an integrated key configured to engage a powered tool.

16. The clutch of claim 15, wherein the mass of the flywheel is arranged such that more than 50% of the mass is positioned further from the aperture than the shoes, in the extended position, are from the aperture.

17. The clutch of claim 16, wherein the flywheel is a disk formed from powdered metal.

18. The clutch of claim 17, wherein the flywheel includes a lip extending around the periphery of the disk.

19. The clutch of claim 18, wherein the drum has a circular cross-section, and wherein the diameter of the disk is greater than the diameter of the circular cross-section of the drum.

20. The clutch of claim 19, wherein the mass moment of inertia of the centrifugal clutch is between 10-50 lb·in².
